(19) United States
(12) Patent Application Publication
(10) Pub. No.: US 2010/0062618 A1
(43) Pub. Date: Mar. 11, 2010

(54) Integrated assembly of female coaxial cable connector and USB socket

(75) Inventors: Chih-Ming Lai, Hsin-Tien (TW); Yung-Shun Kao, Hsin-Tien (TW)

Correspondence Address: BACON & THOMAS, PLLC, 625 SLATERS LANE, FOURTH FLOOR, ALEXANDRIA, VA, 22314-1176, US

(73) Assignee: GIGA-BYTE TECHNOLOGY CO., LTD., Hsin-Tien (TW)

(21) Appl. No.: 12/230,967

(22) Filed: Sep. 9, 2008

(51) Int. Cl. H01R 12/00

(52) U.S. Cl. 439/63

(57) ABSTRACT

An integrated assembly of a female coaxial cable connector and a universal serial bus (USB) socket, mounted on a printed circuit board, is disclosed. The integrated assembly includes an insulating housing; a plurality of first conductive contacts; a second conductive contact; and a shielding case partially enclosing the insulating housing.

### FIELD OF THE INVENTION

The present invention relates to an integrated assembly of a plurality of input/output connectors of different types mounted on a printed circuit board, and more particularly, to an integrated assembly of a USB socket and a female coaxial cable connector mounted on a printed circuit board.

### BACKGROUND OF THE INVENTION

In recent years, digital products have become an essential part of modern business and been filled in our daily life. With the advancement of chip design and manufacture, the cost of digital products has decreased. Most manufacturers keep looking for ways to more easily, reliably and flexibly assemble digital products. For users, it is important to consider the inner functions and also the entire volume of digital products. It is not convenient for users to use the digital products with large volume. Therefore, more and more digital products make reduction in size for providing lighter weight. While much attention has been paid to advances in chip design and manufacture, comparatively less effort has been put into optimizing the input and output connections to the digital products. Moreover, the electrical connectors of the digital products are also miniaturized constantly for connecting with several peripheral devices. Historically, electrical connectors of the digital products are usually located at the rear of the housing where it is difficult for users to access. Meanwhile, each of those electrical connectors has connecting pins disposed on motherboard of the digital product. Moreover, present techniques for installing connector ports onto the housing of the digital product allow little flexibility to change the type of connector ports being used if the manufacturer wants to use the same connector assembly for several digital products. Usually, the input connections of the digital products often involve input ports for a keyboard, mouse, joystick, microphone, and more recently, multi-use USB connectors; and the output connections of the digital products often involve output ports for a printer, video monitor, modem and audio speakers. More and more manufacturers provide connector assembly for optimizing the input and output connections.

As mentioned above, U.S. Pat. No. 7,118,414 discloses an assembly for allowing input and/or output connectors to be inserted into an electrical device, such as a personal computer. As shown in FIG. 1, a computer attachable bracket 10 is provided which accepts snap-in connector port holders for allowing audio, visual, network, phone, modem and other input/output connectors 11 to be connected to the computer. Although several connectors 11 are assembled together, the input/output connectors 11 are separately connected to the printed circuit board of the computer via several wires 12, and therefore, the mounting area on the printed circuit board can not be reduced. Accordingly, the prior art fails to adequately utilize the mounting area on the printed circuit board. Furthermore, the manufacturing cost of assembly can't be reduced while wires 12 can't be shortened. Hence, it is desired for an assembly of input/output connectors having a reduced connecting distance between the assembly and the printed circuit board which may shorten the length of wires being used, and therefore, reduce the manufacturing cost of the assembly. Furthermore, an assembly having a reduced mounting area is also desperately desired for adequately utilizing the mounting area on the printed circuit board.

Please refer to FIG. 2. It illustrates a shielding shell structure of a mini-USB receptacle of U.S. Pat. No. 7,214,096. As shown in FIG. 2, the shielding shell structure 20 has a mounting surface 20A for connecting with a printed circuit board. Meanwhile, the shielding shell structure 20 is directly engaged with the printed circuit board so as to reduce the connecting distance and to minimize the assembly space in the entire digital products. However, U.S. Pat. No. 7,214,096 lacks flexibility while more and more input/output connectors are introduced to connect with the printed circuit board. According to U.S. Pat. No. 7,214,096, each connector formed in the shielding shell structure mounted on the surface of the printed circuit board would occupy a specific space. When more and more input/output connectors are introduced, the more surface area the printed circuit board has to be provided. Obviously, the prior art fails to integrate multi-type connectors in saving space. Hence, as mentioned above, an assembly of input/output connectors having not only a reduced connecting distance between the assembly and the printed circuit board but also a reduced mounting area is desperately desired for adequately utilizing the mounting area on the printed circuit board.

Although several assembling structures of input/output connectors with printed circuit board according to the prior arts are technically feasible, in practice the entire assembly can't be miniaturized effectively. Mainly, the mounting area of the printed circuit board can't be utilized effectively, and several input/output connectors of different types can't be adequately stacked together. The prior arts fail to disclose an assembling structure of input/output connectors, in which the input/output connectors are integrated together for decreasing the entire mounting area on a printed circuit board. Therefore, it needs to provide an integrated assembly of input/output connectors of different types without increasing the entire mounting area on the printed circuit board.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

It is an object of the present invention to provide an integrated input/output connectors mounted on a printed circuit board by means of stacking several input/output connectors of different types without increasing the entire mounting area on the printed circuit board, thereby adequately utilizing the mounting area on the printed circuit board.

In accordance with an aspect of the present invention, an integrated assembly of a female coaxial cable connector and a universal serial bus (USB) socket, mounted on a printed circuit board, is disclosed. The integrated assembly includes an insulating housing having two side walls parallel to each other, a front side having a first engaging unit for engaging with a USB plug and a second engaging unit for engaging with a male coaxial cable connector, and a rear side having a plurality of channels defined therein, wherein the front side and the two side walls form an opening therebetween. The integrated assembly further includes a plurality of first conductive contacts partially disposed within the plurality of channels, respectively, each of the plurality of first conductive contacts having one end extending from the first engaging unit and the other end protruding from the opening; a second conductive contact having one end extending from the second engaging unit and the other end protruding from the opening; and a shielding case partially enclosing the insulating housing while exposing the first engaging unit and the second engaging unit. The USB plug electronically connects to the printed circuit board via the plurality of first conductive contacts, and the male coaxial cable connector electronically connects to the printed circuit board via the second conductive contact.

Preferably, the shielding case includes a plurality of first orientating elements for fastening the shielding case onto the printed circuit board.

Preferably, the integrated assembly further includes a metal jacket, disposed around the second engaging unit, having a plurality of second orientating elements for fastening the metal jacket onto the printed circuit board, and having an outer metal ring for grounding the male coaxial cable connector.

Certainly, the insulating housing includes a slot between either one of the side walls and the second engaging unit for engaging with the metal jacket.

Certainly, the insulating housing includes a protruding part on either one of the side walls, and the metal jacket includes a cavity corresponding to the protruding part for engaging with the insulating housing.

Preferably, the second conductive contact includes an inner metal ring on the one end for embracing the male coaxial cable connector.

Preferably, the first engaging unit is disposed above the second engaging unit.

Preferably, the plurality of channels are parallel to one another, and are vertical to the printed circuit board.

Preferably, the second conductive contact is disposed between the front side of the insulating housing and the plurality of first conductive contacts.

In accordance with another aspect of the present invention, the integrated assembly mounted on a printed circuit board, includes at least a universal serial bus (USB) socket having a plurality of first conductive contacts protruding from a surface, thereby forming a mounting area on the printed circuit board, wherein the plurality of first conductive contacts electrically connect the USB socket with the printed circuit board; and a female coaxial cable connector, having a second conductive contact, and being stacked and disposed below the USB socket, wherein the second conductive contact electrically connects the female coaxial cable connector with the printed circuit board. The second conductive contact is disposed within the mounting area, thereby adequately utilizing the mounting area on the printed circuit board.

Preferably, the integrated assembly further includes a shielding case partially enclosing the USB socket and the female coaxial cable connector.

Certainly, the shielding case includes a plurality of first orientating elements for fastening the USB socket onto the printed circuit board.

Preferably, the female coaxial cable connector includes a metal jacket having a plurality of second orientating elements for fastening the female coaxial cable connector onto the printed circuit board.

Certainly, the metal jacket comprises an outer metal ring for grounding a male coaxial cable connector.

Preferably, the second conductive contact includes an inner metal ring on the one end for embracing a male coaxial cable connector.

Preferably, the USB socket includes an insulating housing having a plurality of channels formed on a rear side of the insulating housing.

Certainly, the plurality of channels are parallel to one another, and are vertical to the printed circuit board.

Certainly, the plurality of first conductive contacts are partially disposed within the plurality of channels, respectively.

Preferably, the female coaxial cable connector includes a metal jacket and the USB socket includes an insulating housing.

Certainly, the insulating housing, having two side walls, includes a protruding part on either one of the side walls, and the metal jacket includes a cavity corresponding to the protruding part for engaging with the insulating housing.

### BRIEF DESCRIPTION OF THE DRAWING

The above objects and advantages of the present invention will become more readily apparent to those ordinarily skilled in the art after reviewing the following detailed description and accompanying drawings, in which:

FIG. 1 illustrates an integrated assembly of multi-type connectors according to the prior art;

FIG. 2 illustrates a shielding shell structure of a mini-USB receptacle according to the prior art;

FIGS. 3A-3B illustrate an integrated assembly of double USB sockets and a female coaxial cable connector according to the present invention;

FIG. 4A is an explosive view of the integrated assembly according to the present invention; and

FIG. 4B illustrates each component of the integrated assembly according to the present invention.

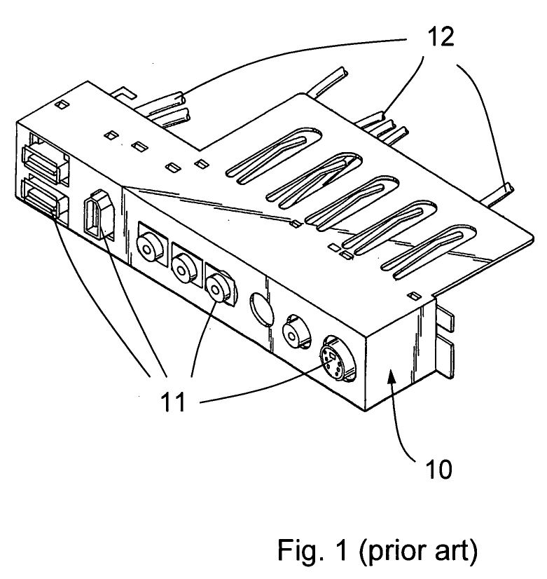

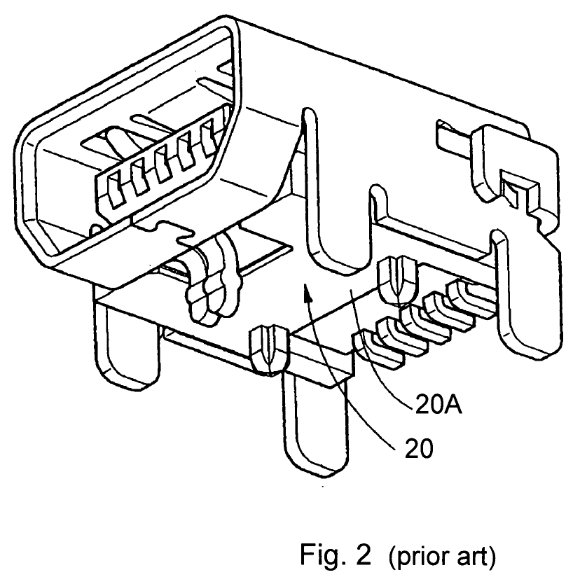

### DETAILED DESCRIPTION OF THE PREFERRED EMBODIMENT

The present invention will now be described more specifically with reference to the following embodiment. It is to be noted that the following descriptions of preferred embodiment of this invention are presented herein for purpose of illustration and description only; it is not intended to be exhaustive or to be limited to the precise form disclosed.

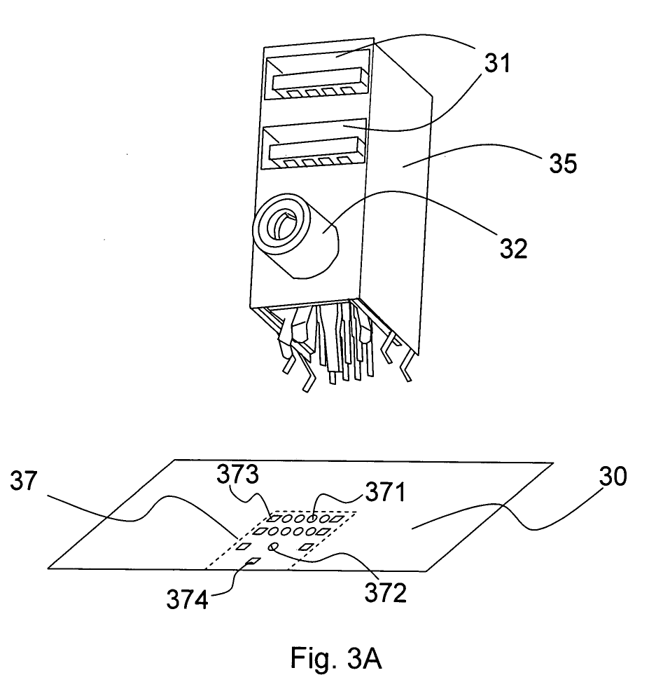

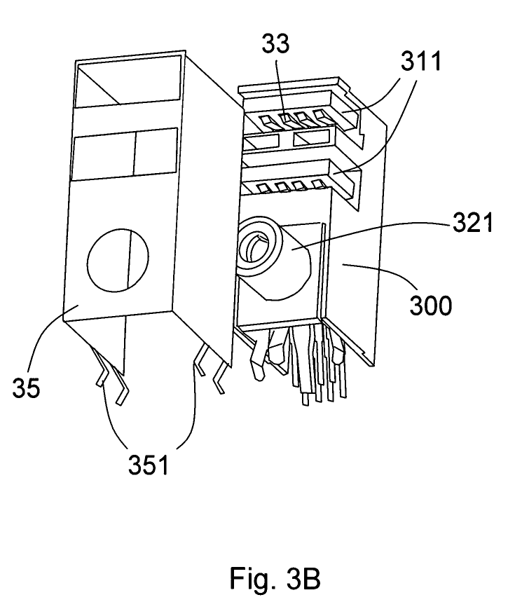

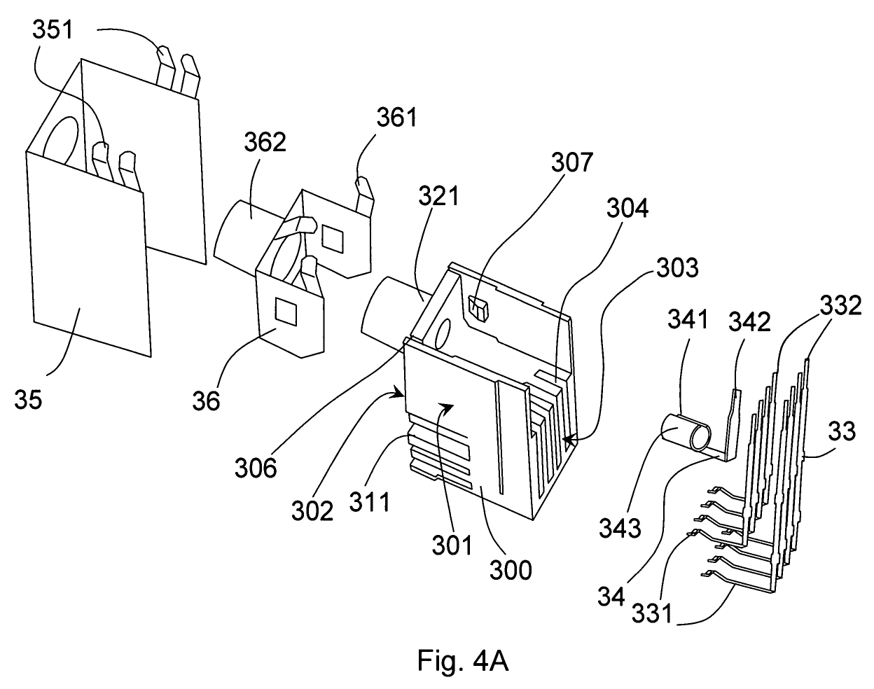

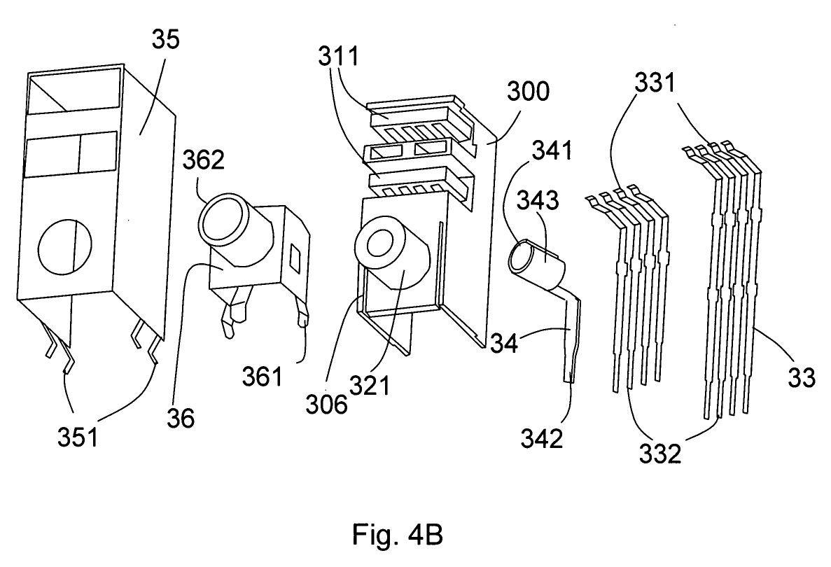

Please refer to FIGS. 3A-3B and 4A-4B. FIGS. 3A-3B illustrate an integrated assembly of double universal serial bus (USB) sockets 31 and a female coaxial cable connector 32. FIG. 4A is an explosive view of the integrated assembly; and FIG. 4B illustrates each component of the integrated assembly.

As shown, the integrated assembly of the double USB sockets 31 and the female coaxial cable connector 32, mounted on a printed circuit board 30, includes eight (8) first conductive contacts 33, a second conductive contact 34, a shielding case 35, a metal jacket 36, and an insulating housing 300. The insulating housing 300 has two side walls 301 parallel to each other, a front side 302, and a rear side 303. As shown in FIGS. 4A-4B, the insulating housing 300 has an opening formed between the front side 302 and the two side walls 301, leaving the rear side 303 suspended above the printed circuit board 30.

On the rear side 303, eight (8) channels 304 are defined therein for holding the first conductive contacts 33 separately so that the first conductive contacts 33 maintain spatially apart from each other without being electrically contacted. The channels 304 are parallel to one another, and are vertical to the printed circuit board 30.

In this embodiment, the insulating housing 300 has a pair of first engaging units 311 on the front side 302 for engagement with a USB plug (not shown). The USB plug (not shown) is then electronically connected to the printed circuit board 30 via the first conductive contacts 33. Meanwhile, the insulating housing 300 also has a second engaging unit 321 on the front side 302 for engagement with a male coaxial cable connector (not shown). Hence, the second engaging unit 321 is shaped as a hollow cylinder. The first conductive contacts 33 electrically connect the USB socket 31 with the printed circuit board 30. In other words, the male coaxial cable connector (not shown) is electronically connected to the printed circuit board 30 via the second conductive contact 34.

The channels 304 aforementioned are extended from the rear side 303 of the insulating housing 300 to each of the first engaging unit 311, and therefore, the first conductive contacts 33, each having one end 331 extending from the first engaging unit 311 and the other end 332 protruding from the opening, are remained spatially apart from one another on the first engaging unit 311. In other words, the first conductive contacts 33 are not completely disposed within the channels 304, but partially disposed therein, leaving the other end 332 of the first conductive contacts 33 exposed for connecting with the printed circuit board 30, thereby forming a mounting area 37.

As shown in FIGS. 4A-4B, the second conductive contact 34 has one end 341 extending from the second engaging unit 321 and the other end 342 protruding from the opening. The second conductive contact 34 is disposed between the front side 302 of the insulating housing 300 and the first conductive contacts 33. That is to say, the second conductive contact 34 is disposed within the mounting area 37 formed by the first conductive contacts 33, thereby adequately utilizing the mounting area 37 on the printed circuit board 30. The one end 341 of the second conductive contact 34 has an inner metal ring 343 disposed within the second engaging unit 321 for embracing the male coaxial cable connector (not shown).

The shielding case 35 partially encloses the insulating housing 300 while has the first engaging unit 311 and the second engaging unit 321 exposed. Furthermore, the shielding case 35 includes four (4) first orientating elements 351 for fastening the shielding case 35 onto the printed circuit board 30. Due to the fact that the insulating housing 300 is connected to the printed circuit board 30 merely by the first conductive contacts 33 and the second conductive contact 34, the first conductive contacts 33 and the second conductive contact 34 may be easily deformed while an external force is exerted during plugging/unplugging process of a USB plug (not shown) or a male coaxial cable connector (not shown). In other words, the first orientating elements 351 are used to intensify the connection between the insulating housing 300 and the printed circuit board 30.

Similarly, the metal jacket 36 has three (3) second orientating elements 361 for fastening the metal jacket 36 onto the printed circuit board 30, and for preventing the second conductive contact 34 from being deformed while an external force is exerted during plugging/unplugging process of a male coaxial cable connector (not shown).

The metal jacket 36 includes an outer metal ring 362, disposed around the second engaging unit 321, for grounding the male coaxial cable connector (not shown).

The insulating housing 300 includes a slot 306 between either one of the side walls 301 and the second engaging unit 321, and a protruding part 307 on either one of the side walls 301 for engaging with the metal jacket 36, whereas the metal jacket 36 includes a cavity corresponding to the protruding part 307 for engaging with the insulating housing 300.

The second conductive contact 34, shielding case 35 and the metal jacket 36 can be made of metal materials by means of stamping. The insulating housing 300 can be made of insulating materials, such as plastic, by means of injection molding.

As shown in FIG. 3A, the mounting area 37 includes eight (8) first contacts 371 corresponding to the first conductive contacts 33 of the double USB sockets 31, a second contact 372 corresponding to the second conductive contact 34 of the female coaxial cable connector 32, four (4) third contacts 373 corresponding to the first orientating elements 351, and three (3) fourth contacts 374 corresponding to the second orientating elements 361.

It should be known that the first conductive contacts 33, the channels 304, the first orientating elements 351 and the second orientating elements 361 should not be limited to the amounts disclosed herein.

The mounting area 37 of the integrated assembly of the present invention has a size equal to that of a traditional connector having double USB sockets. Hence, the integrated assembly can be mounted on a traditional printed circuit board for double USB sockets to be mounted, by adding the second contact 372 and the fourth contacts 374. Hence, compared with the prior art, the present invention provides an stacked input/output connectors mounted on the printed circuit board 30 without increasing the entire mounting area 37 on the printed circuit board 30.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An integrated assembly of a female coaxial cable connector and a universal serial bus (USB) socket, mounted on a printed circuit board, comprising:
an insulating housing having two side walls parallel to each other, a front side having a first engaging unit for engaging with a USB plug and a second engaging unit for engaging with a male coaxial cable connector, and a rear side having a plurality of channels defined therein, wherein the front side and the two side walls form an opening therebetween;
a plurality of first conductive contacts partially disposed within the plurality of channels, respectively, each of the plurality of first conductive contacts having one end extending from the first engaging unit and the other end protruding from the opening;
a second conductive contact having one end extending from the second engaging unit and the other end protruding from the opening; and
a shielding case partially enclosing the insulating housing while exposing the first engaging unit and the second engaging unit;
wherein the USB plug electronically connects to the printed circuit board via the plurality of first conductive contacts, and the male coaxial cable connector electronically connects to the printed circuit board via the second conductive contact.

2. The integrated assembly according to claim 1, wherein the shielding case comprises a plurality of first orientating elements for fastening the shielding case onto the printed circuit board.

3. The integrated assembly according to claim 1, further comprising a metal jacket, disposed around the second engaging unit, having a plurality of second orientating elements for fastening the metal jacket onto the printed circuit board, and having an outer metal ring for grounding the male coaxial cable connector.

4. The integrated assembly according to claim 3, wherein the insulating housing comprises a slot between either one of the side walls and the second engaging unit for engaging with the metal jacket.

5. The integrated assembly according to claim 3, wherein the insulating housing comprises a protruding part on either one of the side walls, and the metal jacket comprises a cavity corresponding to the protruding part for engaging with the insulating housing.

6. The integrated assembly according to claim 1, wherein the second conductive contact comprises an inner metal ring on the one end for embracing the male coaxial cable connector.

7. The integrated assembly according to claim 1, wherein the first engaging unit is disposed above the second engaging unit.

8. The integrated assembly according to claim 1, wherein the plurality of channels are parallel to one another, and are vertical to the printed circuit board.

9. The integrated assembly according to claim 1, wherein the second conductive contact is disposed between the front side of the insulating housing and the plurality of first conductive contacts.

10. The printed circuit board provided with the integrated assembly of female coaxial cable connector and universal serial bus (USB) socket according to claim 1.

11. An integrated assembly mounted on a printed circuit board, comprising:
at least a universal serial bus (USB) socket having a plurality of first conductive contacts protruding from a surface, thereby forming a mounting area on the printed circuit board, wherein the plurality of first conductive contacts electrically connect the USB socket with the printed circuit board; and
a female coaxial cable connector, having a second conductive contact, and being stacked and disposed below the USB socket, wherein the second conductive contact electrically connects the female coaxial cable connector with the printed circuit board;
wherein the second conductive contact is disposed within the mounting area, thereby adequately utilizing the mounting area on the printed circuit board.

12. The integrated assembly according to claim 11, further comprising a shielding case partially enclosing the USB socket and the female coaxial cable connector.

13. The integrated assembly according to claim 12, wherein the shielding case comprises a plurality of first orientating elements for fastening the USB socket onto the printed circuit board.

14. The integrated assembly according to claim 11, wherein the female coaxial cable connector comprises a metal jacket having a plurality of second orientating elements for fastening the female coaxial cable connector onto the printed circuit board.

15. The integrated assembly according to claim 14, wherein the metal jacket comprises an outer metal ring for grounding a male coaxial cable connector.

16. The integrated assembly according to claim 11, wherein the second conductive contact comprises an inner metal ring on the one end for embracing a male coaxial cable connector.

17. The integrated assembly according to claim 11, wherein the USB socket comprises an insulating housing having a plurality of channels formed on a rear side of the insulating housing.

18. The integrated assembly according to claim 17, wherein the plurality of channels are parallel to one another, and are vertical to the printed circuit board.

19. The integrated assembly according to claim 17, wherein the plurality of first conductive contacts are partially disposed within the plurality of channels, respectively.

20. The integrated assembly according to claim 11, wherein the female coaxial cable connector comprises a metal jacket and the USB socket comprises an insulating housing.

21. The integrated assembly according to claim 20, wherein the insulating housing, having two side walls, comprises a protruding part on either one of the side walls, and the metal jacket comprises a cavity corresponding to the protruding part for engaging with the insulating housing.

22. The printed circuit board provided with the integrated assembly of female coaxial cable connector and universal serial bus (USB) socket according to claim 11.
